(19) United States
(12) Patent Application Publication
(10) Pub. No.: US 2004/0181704 A1
(43) Pub. Date: Sep. 16, 2004

(54) Clock skew reduction technique based on local thermal profiling

(76) Inventors: Claude R. Gauthier, Cupertino, CA (US); Shaishav Desai, Sunnyvale, CA (US)

Correspondence Address: OSHA & MAY L.L.P./SUN, 1221 MCKINNEY, SUITE 2800, HOUSTON, TX, 77010, US

(21) Appl. No.: 10/385,335

(22) Filed: Mar. 10, 2003

(51) Int. Cl. G06F 1/04

(52) U.S. Cl. 713/503

(57) ABSTRACT

A method and apparatus for adjusting clock skew involves sensing a temperature at a location on a microprocessor. A temperature sensor indicates a temperature value of the location on the microprocessor. The temperature value is monitored, and a tunable buffer is adjusted dependent on the monitoring. The tunable buffer is used to adjust clock skew. A memory is arranged to store an adjustment value for the tunable buffer.

### BACKGROUND OF INVENTION

As shown in FIG. 1, a typical computer system (10) has, among other components, a microprocessor (12), one or more forms of memory (14), integrated circuits (IC) (16) having specific functionalities, and peripheral computer resources (not shown), e.g., monitor, keyboard, software programs, etc. These components communicate with one another via communication paths (19), e.g., wires, buses, etc., to accomplish the various tasks of the computer system (10).

In order to properly accomplish such tasks, the computer system (10) relies on the basis of time to coordinate its various operations. To that end, a crystal oscillator (18) generates a system clock signal (referred to and known in the art as “reference clock” and shown in FIG. 1 as SYS₁₃CLK) to various parts of the computer system (10). Modern microprocessors and other integrated circuits, however, are typically capable of operating at frequencies significantly higher than the system clock signal, and thus, it becomes important to ensure that operations involving the microprocessor (12) and the other components of the computer system (10) use a proper and accurate reference of time.

One component used within the computer system (10) to ensure a proper reference of time among the system clock signal and a microprocessor clock signal, i.e., “chip clock signal” or CHIP₁₃CLK, is a type of clock generator known as a phase locked loop (PLL) (20). The PLL (20) is an electronic circuit that controls an oscillator such that the oscillator maintains a constant phase relative to the system clock signal. Referring to FIG. 1, the PLL (20) has as its input the system clock signal, which is its reference signal, and outputs a chip clock signal (shown in FIG. 1 as CHIP₁₃CLK) to the microprocessor (12). The system clock signal and chip clock signal have a specific phase and frequency relationship controlled by the PLL (20). This relationship between the phase and frequency of the system clock signal and chip clock signal ensures that the various components within the microprocessor (12) use a controlled and accounted for reference of time. When this relationship is not maintained by the PLL (20), however, the operations within the computer system (10) become non-deterministic.

FIG. 2 shows a block diagram of a typical phase locked loop and buffered clock tree (200). The phase locked loop (202) receives a clock signal from clock path (201). The phase locked loop (202) outputs a clock signal on clock path (203). The clock signal on clock path (203) may have an increased frequency compared to the frequency of the clock signal on clock path (201). The phase locked loop (202) drives the clock signal on clock path (203) so that the clock signal on clock path (203) may connect to other circuits using the buffered clock tree (200).

The buffered clock tree (200) includes many buffers (230, 232, 234, 236, 238, 240, 242, 244, 246, 248, 250) to propagate and amplify the clock signal on clock path (203). The buffers (230, 232, 234, 236, 238, 240, 242, 244, 246, 248, 250) may be distributed across a microprocessor (e.g., microprocessor (12) shown in FIG. 1). The phase locked loop (202) receives an input clock signal from part of the buffered clock tree (200) formed by the clock signal on clock path (203).

Accordingly, the phase locked loop (202) may adjust the timing and frequency of the clock signal on clock path (203) to compensate for some of the effects caused by the buffers (230, 232, 234, 236, 238, 240, 242, 244, 246, 248, 250).

A delay, or clock skew, on different branches of the buffered clock tree (200) may vary. Clock skew can be defined as the difference in time between an edge of a clock signal at two different locations in the integrated circuit. Furthermore, clock skew may also account for differences in edge transition rates of a signal in addition to propagation delays. The clock skew may be caused, for example, by different impedances, voltages, process variations, and temperatures. Variations in clock skew are typically accounted for in a microprocessor (e.g., microprocessor (12) shown in FIG. 1) design. As a microprocessor (e.g., microprocessor (12) shown in FIG. 1) clock frequency increases, an acceptable margin for clock skew decreases.

FIG. 3 shows an exemplary thermal profile (300) of an integrated circuit (e.g., microprocessor (12) shown in FIG. 1). The thermal profile (300) has several local hot spots (310) where more heat is generated than other locations on the integrated circuit. The hot spots (310) may have different temperatures, different sizes, different locations, and different effects on local circuits.

Furthermore, the hot spots (310) may change location based on the activities of the integrated circuit. Accordingly, the clock skew of the buffers (230, 232, 234, 236, 238, 240, 242, 244, 246, 248, 250 shown in FIG. 2) in the buffered clock tree (200 shown in FIG. 2) may be affected by the temperature differences across a microprocessor (e.g., microprocessor (12) shown in FIG. 1).

### SUMMARY OF INVENTION

According to one aspect of one or more embodiments of the present invention, an apparatus for adjusting clock skew comprising a first temperature sensor arranged to indicate a first temperature value; a first tunable buffer arranged to adjust a first clock skew dependent on the first temperature value; a first bias generator arranged to adjust the first tunable buffer; and a first memory arranged to store a first adjustment value for the first tunable buffer.

According to another aspect of one or more embodiments of the present invention, a method for adjusting clock skew comprising sensing a first temperature at a first location on a microprocessor; monitoring a first temperature value indicated by the sensing the first temperature; adjusting a first tunable buffer dependent on the monitoring the first temperature value; and storing a first adjustment value dependent on the monitoring the first temperature value.

According to another aspect of one or more embodiments of the present invention, an apparatus for adjusting clock skew comprising means for sensing a temperature at a location on the apparatus; means for monitoring the means for sensing; means for adjusting a delay of a clock signal dependent on the means for monitoring; and means for storing an adjustment value dependent on the means for monitoring.

Other aspects and advantages of the invention will be apparent from the following description and the appended claims.

### BRIEF DESCRIPTION OF DRAWINGS

FIG. 1 shows a block diagram of a typical computer system.

FIG. 2 shows a block diagram of a typical phase locked loop and buffered clock tree.

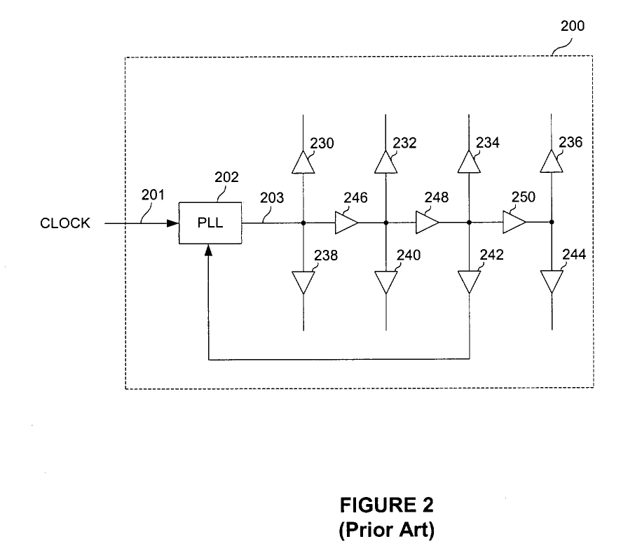

FIG. 3 shows an exemplary thermal profile of an integrated circuit.

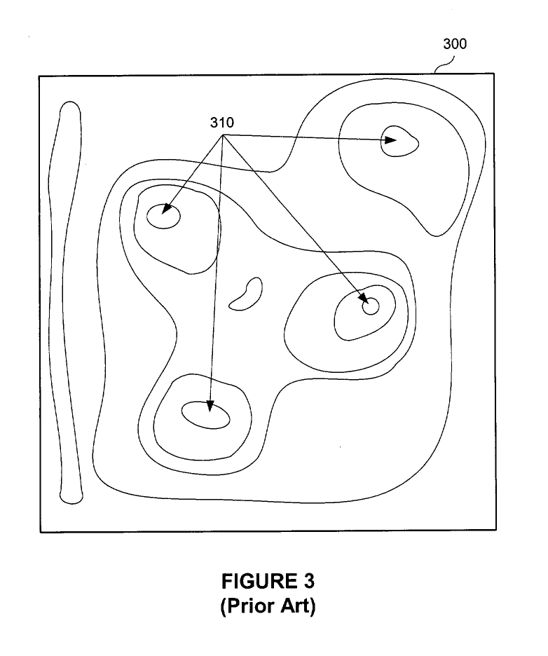

FIG. 4 shows a block diagram of an integrated circuit with a plurality of temperature sensors in accordance with an embodiment of the present invention.

FIG. 5 shows a schematic diagram of a tunable buffer system in accordance with an embodiment of the present invention.

FIG. 6 shows a block diagram of a bias generator in accordance with an embodiment of the present invention.

FIG. 7 shows a block diagram of a microprocessor testing arrangement in accordance with an embodiment of the present invention.

FIG. 8 shows a flow diagram of a clock skew adjustment system in accordance with an embodiment of the present invention.

### DETAILED DESCRIPTION

Embodiments of the present invention relate to a method and apparatus to adjust one or more tunable buffers to reduce clock skew. In certain embodiments, temperature sensors indicate a temperature value. The one or more tunable buffers may be adjusted to reduce the clock skew. A bias generator may be used to adjust the tunable buffers. An adjustment value may be stored in a memory.

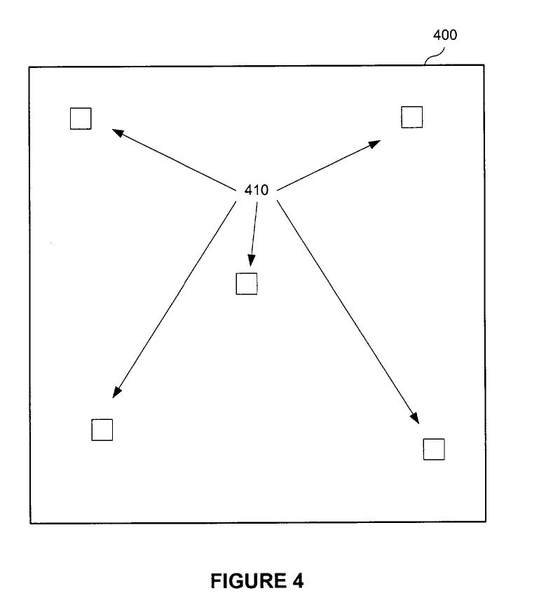

FIG. 4 shows a block diagram of an exemplary integrated circuit (400) with a plurality of temperature sensors (410) in accordance with an embodiment of the present invention. The temperature sensors (410) may be distributed across the integrated circuit (400). Accordingly, the temperature sensors (410) may indicate a temperature value representative of a temperature local to the temperature sensors (410).

One of ordinary skill in the art will understand that one, or more than one, temperature sensor may be used on the integrated circuit (400). Also, the temperature sensors (410) may be arranged in a desired pattern, such as on regions where a temperature may increase more than other regions and/or regions where a temperature shift may have a greater effect. Furthermore, the temperature sensors (410) may be arranged in a grid pattern.

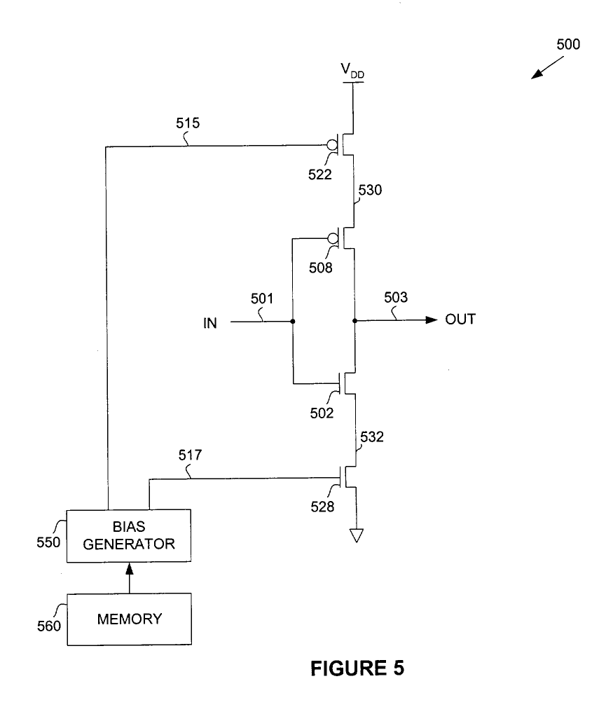

FIG. 5 shows a schematic diagram of an exemplary tunable buffer system (500) in accordance with an embodiment of the present invention. The tunable buffer includes transistors (522, 508, 502, 528). A bias voltage on paths (515, 517) control a current through the tunable buffer. Accordingly, the current from a power supply V_{DD} available on path (530) and the current from a power supply Vₛₛ on path (532) may be controlled. The transistors (508, 502) form an inverter structure. In other words, if an input signal (501) has a high voltage potential, transistor (502) is “on,” and transistor (508) is “off.” Accordingly, an output signal (503) has a low voltage potential. Conversely, if the input signal (501) has a low voltage potential, transistor (502) is “off,” and transistor (508) is “on.” Accordingly, the output signal (503) has a high voltage potential.

The transistors (522, 528) control a rate of transition between the low voltage potential and high voltage potential, and vice versa. Accordingly, if the input signal (501) is a clock signal, a delay of the clock signal may be controlled.

Such control of the clock signal may facilitate the reduction of clock skew with respect to the receipt of the clock signal at other locations.

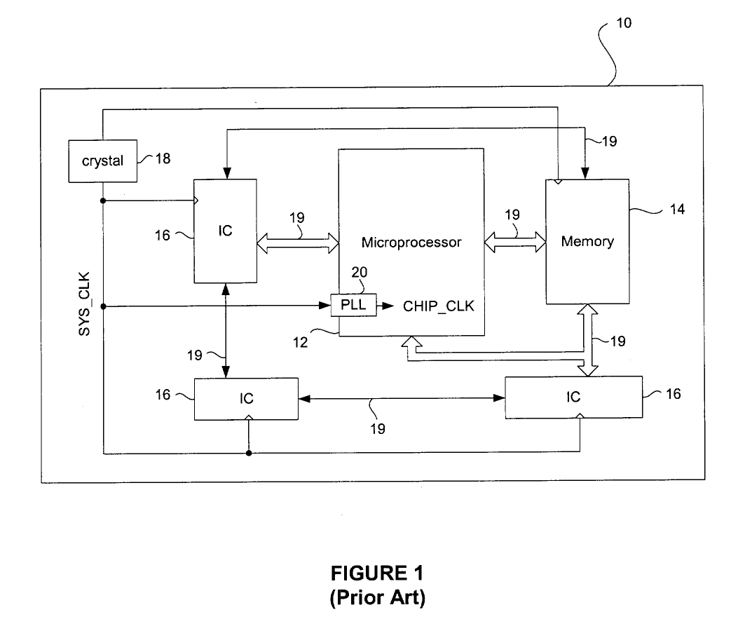

A bias generator (550) controls the bias voltage on paths (515, 517). A change in the bias voltage on either path (515, 517) may change the clock skew through the tunable buffer. Furthermore, a memory (560) may be used to store an adjustment value for the tunable buffer. The memory (560) may take a wide variety of forms, for example, a fuse, an anti-fuse, an electrically erasable and programmable storage device, and a flash memory device. The memory (560) may be a part of an integrated circuit (e.g., microprocessor (12) shown in FIG. 1), be a part of a separate integrated circuit (e.g., integrated circuit (16) shown in FIG. 1), or a separate integrated circuit.

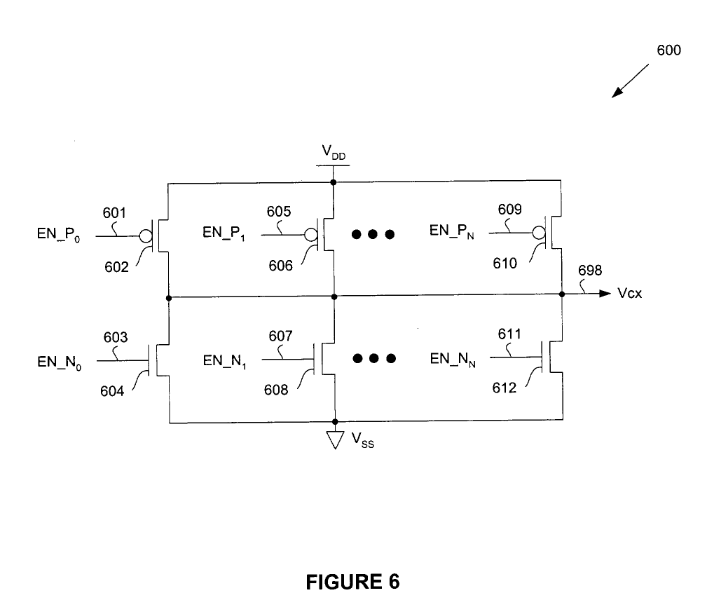

FIG. 6 shows a schematic diagram of an exemplary bias generator (600) in accordance with an embodiment of the present invention. In FIG. 6, the bias generator (600) includes p-channel transistors (602, 606, and 610) arranged in parallel with each other. The p-channel transistors (602, 606, and 610) connect between a power supply, Vdd, and a common node, Vcx (698). The common node Vcx (698) provides a biasing signal, e.g., biasing signal (515) shown in FIG. 5. The bias generator (600) also includes n-channel transistors (604, 608, and 612) arranged in parallel with each other. The n-channel transistors (604, 608, and 612) connect between ground, Vss, and the common node, Vcx (698). The p-channel transistors (602, 606, and 610) are controlled by control signals EN₁₃P₀ (601), EN₁₃P₁ (605), and EN₁₃P_{N} (609), respectively. The n-channel transistors (604), (608), and (612) are controlled by control signals EN₁₃N₀ (603), EN₁₃N₁ (607), and EN₁₃N_{N} (611), respectively. A low voltage on any of the EN₁₃P signals (601, 605, and 609) will turn “on” their respective p-channel transistors (602, 606, and 610). A high voltage on any of the EN₁₃N signals (603, 607, and 611) will turn “on” their respective n-channel transistors (604, 608, and 612).

Any p-channel transistor (602, 606, and 610) that is “on” will have a tendency to increase the voltage on Vcx (698) toward Vdd. Any n-channel transistor (604, 608, and 612) that is “on” will have a tendency to lower the voltage on Vcx (698) toward Vss. By selecting which p-channel transistors (602, 606, and 610) and/or n-channel transistors (604, 608, and 612) are “on”, a change in the voltage on Vcx (698) may be achieved.

One of ordinary skill in the art, having benefit of the present invention, will understand that the p-channel transistors (602, 606, and 610) and n-channel transistors (604, 608, and 612) may be turned “on” individually or as a group. The p-channel transistors (602, 606, and 610) and n-channel transistors (604, 608, and 612) may be sized so that each transistor has a different effect as compared to the other transistors, e.g., a transistor's gate width may be varied to adjust the strength of the transistor. The gate widths may be designed to provide a linear, exponential, or other function as more transistors are turned “on.” The p-channel transistors (602, 606, and 610) and n-channel transistors (604, 608, and 612) may be sized so that each transistor has an inherently resistive nature, e.g., a transistor's gate length may be increased (long-channel transistors) to increase the inherent resistance of the transistor. A larger inherent resistance may be advantageous if both a p-channel transistor and a n-channel transistor are “on” simultaneously. In other embodiments, the bias generator (600) may include only one p-channel transistor and one n-channel transistor connected in series.

The control signals EN N (603, 607, and 611) and control signals EN₁₃P (601, 605, and 609) may be controlled directly, or indirectly, by information stored in a memory, e.g., memory (560) shown in FIG. 5. Those skilled in the art will appreciate that by selectively controlling the bias generator, the bias generator may be used to adjust a particular bias signal, e.g., bias signal (515 and 517) shown in FIG. 5, within a tunable buffer thereby adjusting current and resistive properties of particular circuitry within the tunable buffer in order to attain a desired propagation delay of a signal responsive to the particular circuitry.

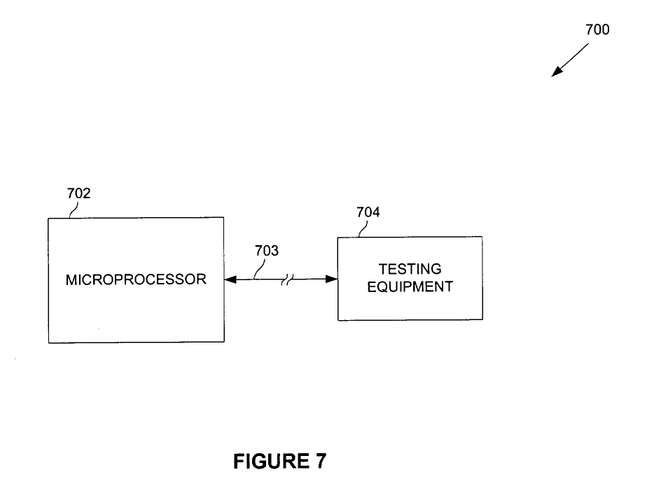

FIG. 7 shows a block diagram of an exemplary microprocessor testing arrangement (700) in accordance with an embodiment of the present invention. The microprocessor testing arrangement (700) includes a microprocessor (702) operatively connected to testing equipment (704) using, at least, path (703). The testing equipment (704) is used to monitor temperature values indicated by temperature sensors on the microprocessor (702). The testing equipment (704) may take a wide variety of forms, for example, an integrated circuit tester for a packaged integrated circuit, an integrated circuit tester for internal probe of an integrated circuit, and an electron beam tester.

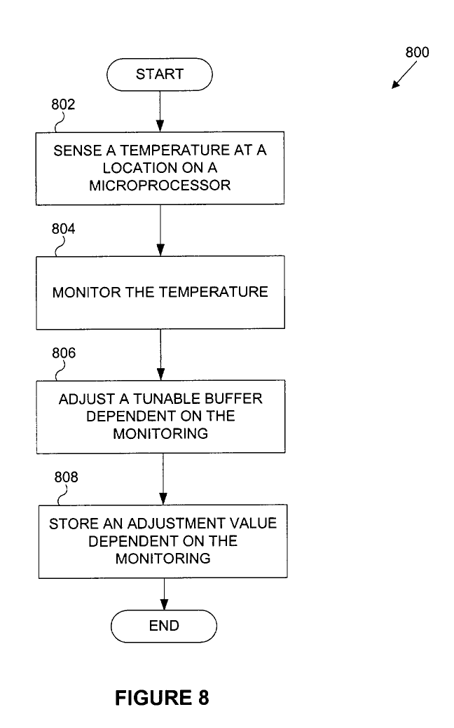

FIG. 8 shows an exemplary flow diagram (800) of a clock skew adjustment system in accordance with an embodiment of the present invention. A microprocessor (e.g., microprocessor (702) in FIG. 7) is operated and a temperature at a location on a microprocessor (e.g., microprocessor (702) in FIG. 7) is sensed (step 802). The temperature sensor is monitored (step 804). For example, testing equipment (e.g., testing equipment (704) shown in FIG. 7) monitors a temperature value indicated by the at least one temperature sensor. Because the location of the temperature sensor and a location of a tunable buffer on the microprocessor is known, an effect of the temperature on the tunable buffer may be determined. Accordingly, the tunable buffer is adjusted to offset the effect of the temperature on clock skew dependent on the monitoring (step 806). An adjustment value, determined from the monitoring, is stored (step 808).

As mentioned above, the adjustment to the tunable buffer may be stored in a memory (e.g., memory (560) shown in FIG. 5). Accordingly, the testing equipment (e.g., testing equipment (704) shown in FIG. 7) may no longer be required or operatively connected to the microprocessor.

One of ordinary skill in the art, having benefit of this disclosure, will understand that one or more of temperature sensors and one or more tunable buffers may be included in the microprocessor. Also, obtaining a temperature value from the one or more temperature sensors may be accomplished through a wide variety of means. Furthermore, storing an adjustment value for the one or more tunable buffers may be accomplished through the microprocessor itself or means external to the microprocessor.

Advantages of the present invention may include one or more of the following. In one or more embodiments, a temperature sensor indicates a temperature value that may be used to adjust a tunable buffer. Accordingly, an effect of a temperature value on a region of the microprocessor may be known. Furthermore, the effect on clock skew may be offset using a tunable buffer.

In one or more embodiments, because a tunable buffer is adjusted to reduce clock skew, a margin needed to account for clock skew may be reduced.

In one or more embodiments, because an adjustment for clock skew through a tunable buffer is stored, the adjustment may advantageously applied for an operational lifetime of a microprocessor.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for adjusting clock skew, comprising:
a first temperature sensor arranged to indicate a first temperature value;
a first tunable buffer arranged to adjust a first clock skew dependent on the first temperature value;
a first bias generator arranged to adjust the first tunable buffer; and
a first memory arranged to store a first adjustment value for the first tunable buffer.

2. The apparatus of claim 1, wherein the first memory is selected from at least one of a fuse, an anti-fuse, an electrically erasable and programmable storage device, and a flash memory device.

3. The apparatus of claim 1, wherein the first memory stores the first adjustment value dependent on testing equipment.

4. The apparatus of claim 3, wherein the testing equipment is selected from at least one of an integrated circuit tester for a packaged integrated circuit, an integrated circuit tester for internal probe of an integrated circuit, and an electron beam tester.

5. The apparatus of claim 1, wherein the first tunable buffer is arranged within a clock tree.

6. The apparatus of claim 1, further comprising:
a second temperature sensor arranged to indicate a second temperature value;
a second tunable buffer arranged to adjust a second clock skew dependent on the second temperature sensor; and
a second bias generator arranged to adjust the second tunable buffer.

7. The apparatus of claim 6, further comprising:
a second memory arranged to store a second adjustment value for the second tunable buffer.

8. The apparatus of claim 7, wherein the second memory is selected from at least one of a fuse, an anti-fuse, an electrically erasable and programmable storage device, and a flash memory device.

9. The apparatus of claim 7, wherein the second memory stores the second adjustment value dependent on testing equipment.

10. The apparatus of claim 9, wherein the testing equipment is selected from at least one of an integrated circuit tester for a packaged integrated circuit, an integrated circuit tester for internal probe of an integrated circuit, and an electron beam tester.

11. The apparatus of claim 6, wherein the second tunable buffer is arranged within a clock tree.

12. A method for adjusting clock skew, comprising:
sensing a first temperature at a first location on a microprocessor;
monitoring a first temperature value indicated by the sensing the first temperature;
adjusting a first tunable buffer dependent on the monitoring the first temperature value; and
storing a first adjustment value dependent on the monitoring the first temperature value.

13. The method of claim 12, wherein the monitoring the first temperature value comprises using testing equipment.

14. The method of claim 12, wherein the adjusting the first tunable buffer comprises using a bias generator.

15. The method of claim 12, wherein the sensing comprises using a first temperature sensor.

16. The method of claim 12, further comprising:
sensing a second temperature at a second location on the microprocessor; and
monitoring a second temperature value indicated by the sensing the second temperature.

17. The method of claim 16, further comprising:
storing a second adjustment value dependent on the monitoring the second temperature value.

18. The method of claim 16, further comprising:
adjusting a second tunable buffer dependent on the monitoring the second temperature value.

19. The method of claim 18, wherein the adjusting the second tunable buffer comprises using a bias generator.

20. An apparatus for adjusting clock skew, comprising:
means for sensing a temperature at a location on the apparatus;
means for monitoring the means for sensing;
means for adjusting a delay of a clock signal dependent on the means for monitoring; and
means for storing an adjustment value dependent on the means for monitoring.
